(19) United States
(12) Patent Application Publication
(10) Pub. No.: US 2015/0338681 A1
(43) Pub. Date: Nov. 26, 2015

(54) METHOD FOR MANUFACTURING A COLORED CONTACT LENS

(71) Applicant: BenQ Materials Corporation, Taoyuan City (TW)

(72) Inventors: Pei-Yi LIU, Taoyuan City (TW); Hsia-Hao CHANG, Taipei City (TW); Yu-Syun SHIN, Taoyuan City (TW); Mei-Yun CHANG, Taoyuan City (TW)

(21) Appl. No.: 14/637,370

(22) Filed: Mar. 3, 2015

(30) Foreign Application Priority Data
May 23, 2014 (TW) 103118126

(51) Int. Cl. G02C 7/04; G02C 13/00

(52) U.S. Cl. CPC G02C 7/046; G02C 13/001

(57) ABSTRACT

A method for manufacturing a colored contact lens which comprises the steps of: (a) forming a contact lens by polymerizing a polymerizable lens forming material in a mold, wherein the lens forming material includes at least one reactive group; (b) contacting at least a part of the contact lens with a dye solution for a period of time sufficient to form a colored layer within the contact lens, wherein the dye solution includes at least one dye of β-sulphatoethyl sulphone substituted with a sulfonate group; (c) immersing the contact lens with colored layer in a fixing solution; and (d) washing the contact lens; wherein the colored layer is covalently attached to the contact lens.

### RELATED APPLICATIONS

This application claims priority to Taiwanese Application Serial Number 103118126, filed May 23, 2014, which is herein incorporated by reference.

### BACKGROUND

1. Field of Invention

The invention relates to a method for manufacturing contact lens, and more particularly to a method for manufacturing colored contact lens.

2. Description of Related Art

In recent years, besides the original function of vision correction, contact lenses have become a cosmetic tool due to the development of colored contact lenses. Using colored contact lens with pattern to alter or enhance the natural color of the iris or make the iris have a pattern have been popular for years. Therefore, a need for colored contact lens has been substantially increased.

A conventional colored contact lens is manufactured by pad printing, laser printing or other known printing method to transfer a colored layer on a surface of the contact lens. However, the above mentioned methods are manufactured by transferring a 0.01 mm to 0.5 mm of pigment on the surface of contact lens to form predetermined pattern or color. Although the thickness of the colored layer is thin, wearer might still feel uncomfortable while wearing colored contact lens. In addition, the diameter of inorganic pigment particle used in conventional methods is be controlled at 5 μm or less, but the cases around the world show that the cornea of long-term colored contact lens wearers might be abraded because the uneven surface of conventional colored contact lens caused by the pattern or color on the surface of conventional colored contact lens.

Therefore, an aspect of the present invention is to provide a novel method for manufacturing a colored contact lens and a colored contact lens manufactured by the method. The pattern and color can be formed on the contact lens and will not cause the surface of contact lens uneven to surmount the aforesaid disadvantages of the prior art.

### SUMMARY

The present invention is directed to a method for manufacturing a colored contact lens, and a colored contact lens manufactured thereof. Because the colored layer of the colored contact lens manufactured by the method of the present invention is covalently attached to the contact lens, the present colored contact lens provides better comfortability of wearing for wearers and can avoid the cornea abrasion caused by the uneven surface of the conventional contact lens.

According to an aspect of the present invention, a method for manufacturing a colored contact lens is provided. In an embodiment of the present invention, the method for manufacturing a colored contact lens includes the steps of: (a) forming a contact lens by polymerizing a polymerizable lens forming material in a mold, wherein the lens forming material includes at least one reactive group; (b) contacting at least a part of the contact lens with a dye solution for a period of time sufficient to form a colored layer within the contact lens, wherein the dye solution includes at least one dye of β-sulphatoethyl sulphone substituted with a sulfonate group; (c) immersing the contact lens with colored layer in a fixing solution; and (d) washing the contact lens; wherein the colored layer is covalently attached to the contact lens.

In an embodiment of the present invention, the method for manufacturing a colored contact lens further includes a step of: placing the contact lens into a patterned masking mold for masking the at least a part of the contact lens before the step of (b), wherein the unmasked part of the contact lens contacts the dye solution.

In an embodiment of the present invention, the patterned masking mold includes: a holding element including a patterned masking member for masking the at least a part of the contact lens; an upper cover which is capable of coupling with the holding element for clamping the contact lens; and a contact lens containing spatial area disposed between the holding element and the upper cover; wherein the patterned masking member masks the at least a part of the contact lens when placing the contact lens into the holding element.

In an embodiment of the present invention, wherein the reactive group includes at least one group of hydroxyl group, amino group, amido group or sulfhydryl group.

In an embodiment of the present invention, wherein a concentration of the dye solution is in the range of 0.1% to 2%.

In an embodiment of the present invention, wherein the dye of β-sulphatoethyl sulphone substituted with a sulfonate group is selected from a group consisting of C.I. Reactive Yellow 14, C.I. Reactive Yellow 15, C.I. Reactive Yellow 17, C.I. Reactive Orange 7, C.I. Reactive Orange 16, C.I. Reactive Orange 72, C.I. Reactive Orange 78, C.I. Reactive Black 5, C.I. Reactive Red 23, C.I. Reactive Red 49, C.I. Reactive Red 180, C.I. Reactive Blue 19, C.I. Reactive Blue 20 and C.I. Reactive Blue 21 and a combination thereof.

In an embodiment of the present invention, wherein in the step (b), the time of contacting the at least a part of the contact lens with the dye solution is in the range of 30 minutes to 90 minutes.

In an embodiment of the present invention, wherein the fixing solution is alkali metal hydroxide solution or alkali metal salt solution.

In an embodiment of the present invention, wherein the fixing solution includes at least one of sodium hydroxide solution, potassium hydroxide solution, sodium bicarbonate solution or sodium carbonate solution.

In an embodiment of the present invention, wherein a pH value of the fixing solution is in the range of 11 to 12.5.

In an embodiment of the present invention, wherein the time of immersing the contact lens with colored layer in the fixing solution is in the range of 30 minutes to 60 minutes.

In an embodiment of the present invention, wherein the step (c) further includes conducting under a heating treatment.

In an embodiment of the present invention, wherein the heating treatment is conducted at the temperature in the range of 50° C. to 80° C.

In an embodiment of the present invention, wherein the contact lens is washed in water and alcohol in the step (d).

According to another aspect of the present invention, a colored contact lens which is obtained by the method for manufacturing a colored contact lens is provided.

The forgoing presents a simplified summary of the disclosure in order to provide a basic understanding of the present invention. This summary is not an extensive overview of the disclosure and it does not identify key/critical elements of the present invention or delineate the scope of the present invention. Its sole purpose is to present concepts disclosed herein in a simplified form as a prelude to the more detailed description that is presented later.

Many of the attendant features will be more readily appreciated as the same becomes better understood by reference to the following detailed description considered in connection with the accompanying drawings. It is noteworthy that the drawings shown in the figures are for illustrative purposes only and not to scale.

### BRIEF DESCRIPTION OF THE DRAWINGS

The invention can be more fully understood by reading the following detailed description of the embodiment, with reference made to the accompanying drawings as follows:

FIG. 1 is a flow chart of a method for manufacturing a colored contact lens of an embodiment of the present invention.

FIG. 2 illustrate an explosion diagram of the patterned masking mold of an embodiment of the present invention.

FIG. 3 illustrate a side view of the patterned masking mold of an embodiment of the present invention.

FIG. 4 illustrate a schematic of the patterned masking element of an embodiment of the present invention.

FIG. 5 illustrate a schematic of the colored contact lens of an embodiment of the present invention.

### DETAILED DESCRIPTION

Accordingly, a method for manufacturing a colored contact lens and a colored contact lens manufactured thereof are provided. In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an aspect of the present invention, a method for manufacturing a colored contact lens is provided. The method comprises but not limited to the following steps. The method for manufacturing a colored contact of the present invention is suitable for manufacturing colored hydrogel contact and colored silicon hydrogel contact lens.

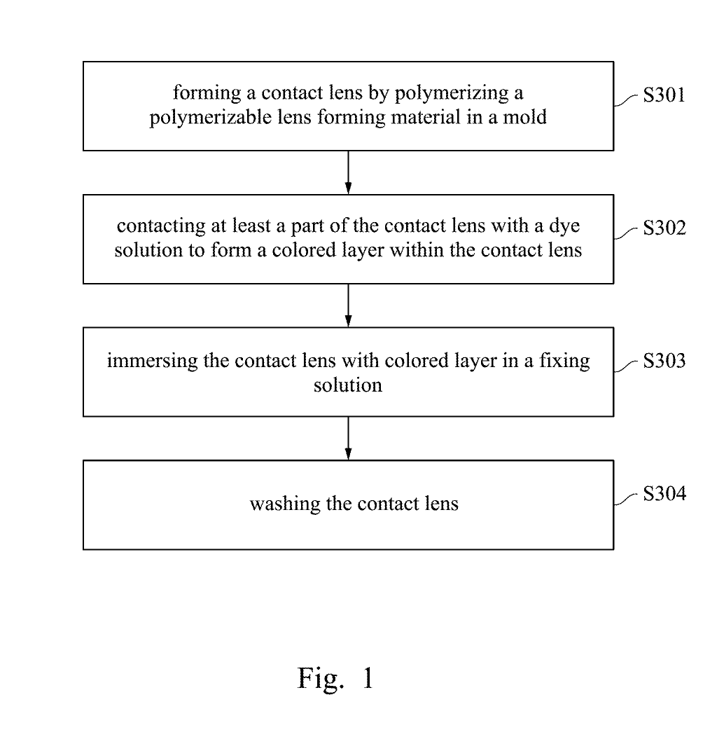

FIG. 1 is a flow chart of a method for manufacturing a colored contact lens of an embodiment of the present invention.

Firstly, a polymerizable lens forming material is polymerized in a mold to form a contact lens in step S301, wherein the lens forming material comprises at least one reactive group, and the reactive group can be one of hydroxyl group, amino group, amido group, sulfhydryl group or a combination thereof. Suitable lens forming material can be conventional lens forming material with reactive group, such as hydroxyethyl methacrylate (HEMA), N-vinylpyrrolidone (NVP) or siloxane macromer, but not limited thereto. In an embodiment of the present invention, the reactive group is a hydroxyl group. In a preferred embodiment of the present invention, lens forming material is cured directly in a polypropylene mold so that a finished lens is produced. The time and method for curing are varied with the particular lens forming material used. In an embodiment of the present invention, the lens forming material is a hydrogel lens forming material. In another embodiment of the present invention, the lens forming material is a silicon hydrogel lens forming material.

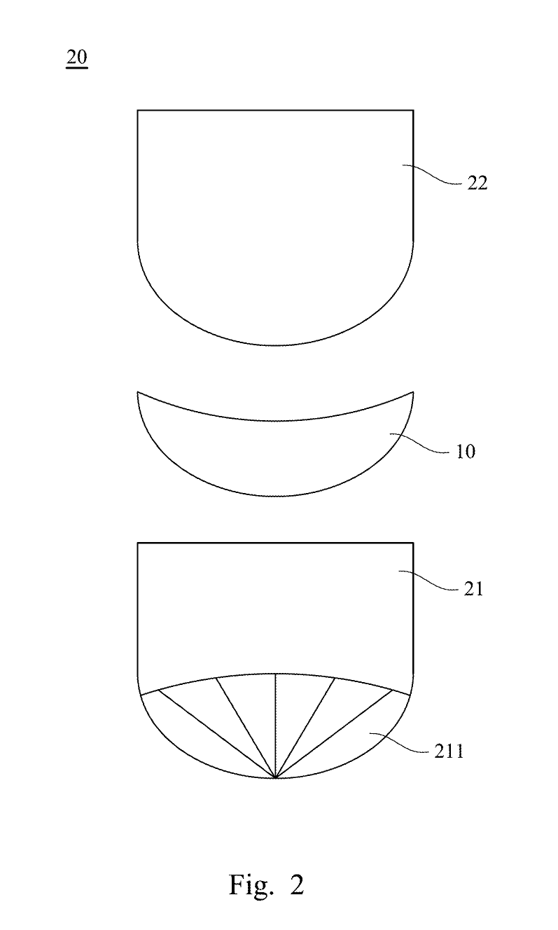

Then, in step S302, at least a part of the contact lens is contacted with a dye solution for a period of time sufficient to form a colored layer within the contact lens. Referring to FIG. 2, in an embodiment of the present invention, the method for making the at least a part of the contact lens 10 contact with a dye solution comprises but not limited to place the contact lens 10 into a patterned masking mold 20 before contacting the dye solution.

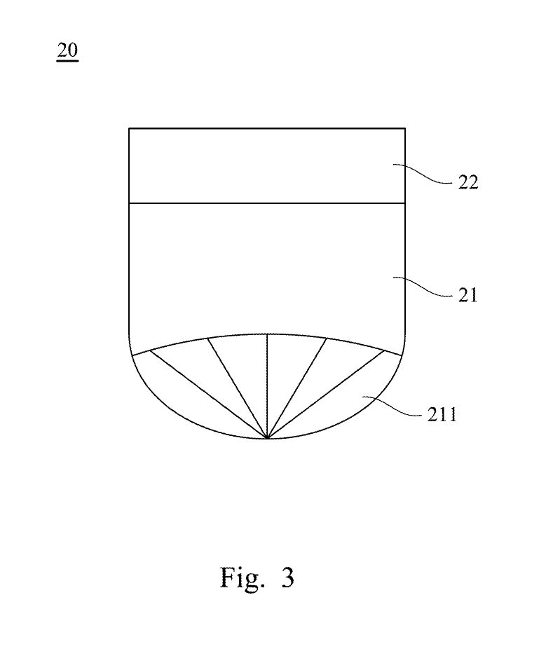

Referring to FIG. 2 together with FIG. 3, FIG. 2 illustrates an explosion diagram of the patterned masking mold 20. FIG. 3 illustrates a side view of the patterned masking mold 20. The patterned masking mold 20 comprises a holding element 21, an upper cover 22 and a contact lens containing spatial area 23 disposed between the holding element 21 and the upper cover 22. The bottom of the holding element 21 includes a patterned masking member 211 for masking the at least a part of the contact lens 10. The pattern of the patterned masking member 211 can be designed differently by different needs. The upper cover 22 is capable of coupling with the holding element 21 for clamping the contact lens 10. To avoid any possible damage to the lens caused in the manufacturing process, the holding element 21 can be made of, such as, polypropylene (PP), polycarbonate (PC) or polyethylene terephthalate (PET). The upper cover 22 can be made of, such as, silicone, rubber or acrylic, but not limited thereto.

In an embodiment of the present invention, the contact lens 10 is placed into the holding element 21 and the upper cover 22 is coupled with the holding element 21 for clamping the contact lens 10, and then the patterned masking mold 20 with contact lens 10 is immersed in the dye solution. Because the patterned masking member 211 masks at least a part of the contact lens 10, the unmasked part of the contact lens 10 can contact the dye solution and form the colored layer.

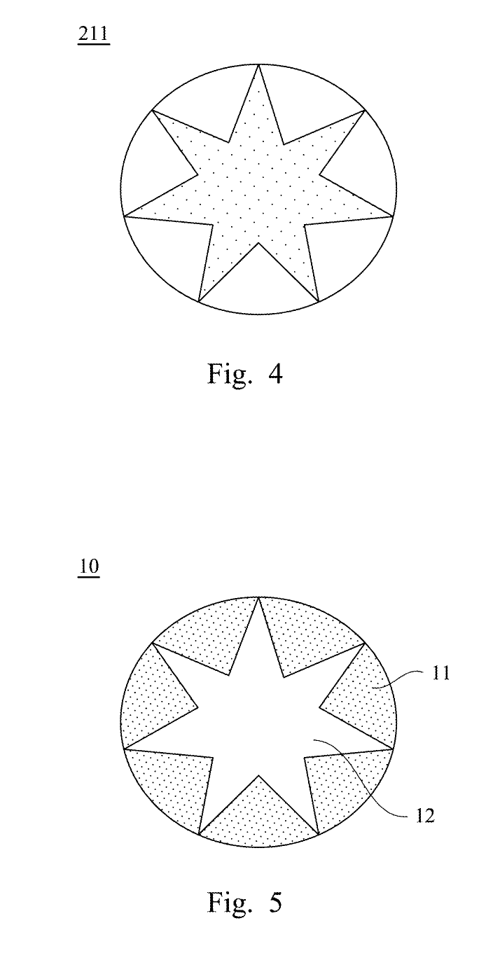

Referring to FIG. 4 together with FIG. 5, FIG. 4 illustrates a schematic of the patterned masking element 211 of an embodiment of the present invention. FIG. 5 illustrates a schematic of the colored contact lens 10 of an embodiment of the present invention. A part 12 of the contact lens 10 is masked by the patterned masking member 211 and is not contacted with the dye solution, thus, this part 12 of the contact lens 10 do not form a colored layer. The unmasked part 11 of the contact lens 10 is unmasked by the patterned masking member 211, thus, the unmasked part 11 of the contact lens 10 forms a colored layer after contacting the dye solution, and the colored layer forms a predetermined pattern. The design of the patterned masking member 211 is relative to the predetermined pattern. Therefore, the pattern of the patterned masking member 211 can be designed by predetermined pattern needed, but not limited thereto.

Referring to FIG. 1, in step S302, a concentration of the dye solution will affect the color shades of the colored layer. In an embodiment of the present invention, the concentration of the dye solution is about in the range of 0.1% to 2%. The dye solution comprises at least one dye of β-sulphatoethyl sulphone substituted with a sulfonate group. Suitable dye of β-sulphatoethyl sulphone substituted with a sulfonate group can be but not limited to C.I. Reactive Yellow 14, C.I. Reactive Yellow 15, C.I. Reactive Yellow 17, C.I. Reactive Orange 7, C.I. Reactive Orange 16, C.I. Reactive Orange 72, C.I. Reactive Orange 78, C.I. Reactive Black 5, C.I. Reactive Red 23, C.I. Reactive Red 49, C.I. Reactive Red 180, C.I. Reactive Blue 19, C.I. Reactive Blue 20, C.I. Reactive Blue 21 or a combination thereof.

In an embodiment of the present invention, the time of contacting the at least a part of the contact lens with the dye solution is in the range of 30 minutes to 90 minutes, and preferably in the range of 40 minutes to 60 minutes.

After forming the colored layer, the contact lens with colored layer is immersed in a fixing solution in step S303. In an embodiment of the present invention, the fixing solution is alkali metal hydroxide solution or alkali metal salt solution. The fixing solution can be sodium hydroxide solution, potassium hydroxide solution, sodium bicarbonate solution or sodium carbonate solution. Under the effect of fixing solution, a covalent bond between the reaction group of lens forming material and the sulfonate group of β-sulphatoethyl sulphone substituted with a sulfonate group is formed. The colored layer is covalently attached to the contact lens therefore.

In an embodiment of the present invention, the time of contact lens with colored layer immersed in the fixing solution is in the range of 30 minutes to 60 minutes. In an embodiment of the present invention, the fixing solution is sodium hydroxide solution, a pH value of the fixing solution is in the range of 11 to 12.5 and the time of contact lens with colored layer immersed in the fixing solution is about 40 minutes.

In an embodiment of the present invention, a heating treatment can be conducted selectively when immersing the contact lens into the fixing solution. The heating treatment is conducted at a temperature in the range of 50° C. to 80° C.

Finally, in step S304, the contact lens is washed to remove residual fixing solution, unreacted dye and impurities. In an embodiment of the present invention, the contact lens is washed in water and alcohol. In another embodiment of the present invention, a heating treatment can be conducted selectively when washing the contact lens.

According to another aspect of the present invention, a colored contact lens is provided. The colored contact lens is obtained by the method for manufacturing a colored contact lens mentioned above.

Accordingly, because the colored layer is covalently attached to the contact lens, the colored contact lens manufactured by the method for the present invention can avoid cornea abrasion caused by the uneven surface of the conventional contact lens manufactured by pad printing or laser printing pigment on the surface of the contact lens.

The present invention will be explained in further detail with reference to the examples. However, the present invention is not limited to these examples.

### EXAMPLE

### Examples 1-6

### Preparation of Colored Hydrogel Contact Lens Containing C.I. Reactive Blue 19

C.I. Reactive Blue 19 and water as solvent were mixed to prepare a dye solution at the concentration shown in the following Table 1. Hydrogel contact lens SOHO Daily Soft Contact Lens (Available from Miacare, Taiwan) was placed into a patterned masking mold, and the mold with contact lens was immersed in the dye solution at room temperature for 60 minutes. And then the contact lens was immersed in 1% sodium carbonate solution at 80° C. for 40 minutes. Finally, the resulting product was washed by alcohol and water.

The results of physical property tests of Example 1-Example 6 of the present invention were shown as the following Table 1.

Visual Inspection

The colored contact lens was observed by visual inspection to determine whether predetermined pattern forms. In the result of tests, O represents for forming predetermined pattern and X represents for not forming predetermined pattern.

Test of Discoloration

The colored contact lens was soaked in water and wiped on the surface of the contact lens by cotton swabs. In the result of tests, O represents for no discoloration and X represents for discoloration.

TABLE 1
The result of physical property tests of Examples 1-6.

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Concentration | 0.01% | 0.05% | 0.10% | 0.30% | 0.50% | 1% |
| of dye | | | | | | |
| Visual | ◯ | ◯ | ◯ | ◯ | ◯ | ◯ |
| inspection | | | | | | |
| Test of | ◯ | ◯ | ◯ | ◯ | ◯ | ◯ |
| Discoloration | | | | | | |

### Examples 7-12

### Preparation of Colored Hydrogel Contact Lens Containing C.I. Reactive Orange 78

The preparation steps of Examples 7-12 are the same as Examples 1-6, except that the dye was C.I. Reactive Orange 78.

The results of physical property tests of Examples 7-12 of the present invention were shown as the following Table 2.

TABLE 2
The result of physical property tests of Examples 7-12.

| | Exam- | Exam- | Exam- | Exam- | Exam- | Exam- |
|---|---|---|---|---|---|---|
| | ple 7 | ple 8 | ple 9 | ple 10 | ple 11 | ple 12 |
| Concentration | 0.01% | 0.05% | 0.10% | 0.30% | 0.50% | 1% |
| of dye | | | | | | |
| Visual | ◯ | ◯ | ◯ | ◯ | ◯ | ◯ |
| inspection | | | | | | |
| Test of | ◯ | ◯ | ◯ | ◯ | ◯ | ◯ |
| Discoloration | | | | | | |

### Examples 13-18

### Preparation of Colored Hydrogel Contact Lens Containing C.I. Reactive Yellow 15

The preparation steps of Examples 13-18 were the same as Examples 1-6, except that the dye was C.I. Reactive Yellow 15.

The results of physical property tests of Examples 13-18 of the present invention were shown as the following Table 3.

TABLE 3
The result of physical property tests of Examples 13-18.

| | Exam- | Exam- | Exam- | Exam- | Exam- | Exam- |
|---|---|---|---|---|---|---|
| | ple 13 | ple 14 | ple 15 | ple 16 | ple 17 | ple 18 |
| Concentration | 0.01% | 0.05% | 0.10% | 0.30% | 0.50% | 1% |
| of dye | | | | | | |
| Visual | ◯ | ◯ | ◯ | ◯ | ◯ | ◯ |
| inspection | | | | | | |
| Test of | ◯ | ◯ | ◯ | ◯ | ◯ | ◯ |
| Discoloration | | | | | | |

### Examples 19-24

### Preparation of Colored Hydrogel Contact Lens Containing C.I. Reactive Black 5

The preparation steps of Examples 19-24 are the same as Examples 1-6, except that the dye was C.I. Reactive Black 5.

The results of physical property tests of Examples 19-24 of the present invention were shown as the following Table 4.

TABLE 4
The result of physical property tests of Examples 19-24.

| | Exam- | Exam- | Exam- | Exam- | Exam- | Exam- |
|---|---|---|---|---|---|---|
| | ple 19 | ple 20 | ple 21 | ple 22 | ple 23 | ple 24 |
| Concentration | 0.01% | 0.05% | 0.10% | 0.30% | 0.50% | 1% |
| of dye | | | | | | |
| Visual | ◯ | ◯ | ◯ | ◯ | ◯ | ◯ |
| inspection | | | | | | |
| Test of | ◯ | ◯ | ◯ | ◯ | ◯ | ◯ |
| Discoloration | | | | | | |

### Examples 25-30

### Preparation of Colored Hydrogel Contact Lens Containing C.I. Reactive Red 180

The preparation steps of Examples 25-30 are the same as Examples 1-6, except that the dye was C.I. Reactive Red 180.

The results of physical property tests of Examples 25-30 of the present invention were shown as the following Table 5.

TABLE 5
The result of physical property tests of Examples 25-30.

| | Exam- | Exam- | Exam- | Exam- | Exam- | Exam- |
|---|---|---|---|---|---|---|
| | ple 25 | ple 26 | ple 27 | ple 28 | ple 29 | ple 30 |
| Concentration | 0.01% | 0.05% | 0.10% | 0.30% | 0.50% | 1% |
| of dye | | | | | | |
| Visual | ◯ | ◯ | ◯ | ◯ | ◯ | ◯ |
| inspection | | | | | | |
| Test of | ◯ | ◯ | ◯ | ◯ | ◯ | ◯ |
| Discoloration | | | | | | |

### Examples 31-36

### Preparation of Colored Silicon Hydrogel Contact Lens Containing C.I. Reactive Blue 19

C.I. Reactive Blue 19 and water as solvent were mixed to prepare a dye of solution at the concentration shown in the following Table 6. Silicon hydrogel contact lens miacare Silicone Hydrogel 1-Day (Available from Miacare, Taiwan) was placed into a patterned masking mold, and the mold with contact lens was immersed in the dye of solution at room temperature for 60 minutes. And then the contact lens was immersed in 1% sodium carbonate solution at 80° C. for 40 minutes. Finally, the resulting product was washed by alcohol and water.

The results of physical property tests of Example 31-Example 36 of the present invention were shown as the following Table 6. The method for physical property tests were mentioned above.

TABLE 6
The result of physical property tests of Examples 31-36.

| | Exam- | Exam- | Exam- | Exam- | Exam- | Exam- |
|---|---|---|---|---|---|---|
| | ple 31 | ple 32 | ple 33 | ple 34 | ple 35 | ple 36 |
| Concentration | 0.01% | 0.05% | 0.10% | 0.30% | 0.50% | 1% |
| of dye | | | | | | |
| Visual | ◯ | ◯ | ◯ | ◯ | ◯ | ◯ |
| inspection | | | | | | |
| Test of | ◯ | ◯ | ◯ | ◯ | ◯ | ◯ |
| Discoloration | | | | | | |

### Examples 37-42

### Preparation of Colored Silicon Hydrogel Contact Lens Containing C.I. Reactive Orange 78

The preparation steps of Examples 37-42 are the same as Examples 31-36, except that the dye was C.I. Reactive Orange 78.

The results of physical property tests of Examples 37-42 of the present invention were shown as the following Table 7.

TABLE 7
The result of physical property tests of Examples 37-42.

| | Exam- | Exam- | Exam- | Exam- | Exam- | Exam- |
|---|---|---|---|---|---|---|
| | ple 37 | ple 38 | ple 39 | ple 40 | ple 41 | ple 42 |
| Concentration | 0.01% | 0.05% | 0.10% | 0.30% | 0.50% | 1% |
| of dye | | | | | | |
| Visual | ◯ | ◯ | ◯ | ◯ | ◯ | ◯ |
| inspection | | | | | | |
| Test of | ◯ | ◯ | ◯ | ◯ | ◯ | ◯ |
| Discoloration | | | | | | |

### Examples 43-48

### Preparation of Colored Hydrogel Contact Lens Containing C.I. Reactive Yellow 15

The preparation steps of Examples 43-48 were the same as Examples 31-36, except that the dye was CI. Reactive Yellow 15.

The results of physical property tests of Examples 43-48 of the present invention were shown as the following Table 8.

TABLE 8
The result of physical property tests of Examples 43-48.

| | Exam- | Exam- | Exam- | Exam- | Exam- | Exam- |
|---|---|---|---|---|---|---|
| | ple 43 | ple 44 | ple 45 | ple 46 | ple 47 | ple 48 |
| Concentration | 0.01% | 0.05% | 0.10% | 0.30% | 0.50% | 1% |
| of dye | | | | | | |
| Visual | ◯ | ◯ | ◯ | ◯ | ◯ | ◯ |
| inspection | | | | | | |
| Test of | ◯ | ◯ | ◯ | ◯ | ◯ | ◯ |
| Discoloration | | | | | | |

### Examples 49-54

### Preparation of Colored Silicon Hydrogel Contact Lens Containing C.I. Reactive Black 5

The preparation steps of Examples 49-54 are the same as Examples 31-36, except that the dye was C.I. Reactive Black 5.

The results of physical property tests of Examples 49-54 of the present invention were shown as the following Table 9.

TABLE 9
The result of physical property tests of Examples 49-54.

| | Exam- | Exam- | Exam- | Exam- | Exam- | Exam- |
|---|---|---|---|---|---|---|
| | ple 49 | ple 50 | ple 51 | ple 52 | ple 53 | ple 54 |
| Concentration | 0.01% | 0.05% | 0.10% | 0.30% | 0.50% | 1% |
| of dye | | | | | | |
| Visual | ◯ | ◯ | ◯ | ◯ | ◯ | ◯ |
| inspection | | | | | | |
| Test of | ◯ | ◯ | ◯ | ◯ | ◯ | ◯ |
| Discoloration | | | | | | |

### Examples 55-60

### Preparation of Colored Silicon Hydrogel Contact Lens Containing C.I. Reactive Red 180

The preparation steps of Examples 55-60 are the same as Examples 31-36, except that the dye was C.I. Reactive Red 180.

The results of physical property tests of Examples 55-60 of the present invention were shown as the following Table 10.

TABLE 10
The result of physical property tests of Examples 55-60.

| | Exam- | Exam- | Exam- | Exam- | Exam- | Exam- |
|---|---|---|---|---|---|---|
| | ple 55 | ple 56 | ple 57 | ple 58 | ple 59 | ple 60 |
| Concentration | 0.01% | 0.05% | 0.10% | 0.30% | 0.50% | 1% |
| of dye | | | | | | |
| Visual | ◯ | ◯ | ◯ | ◯ | ◯ | ◯ |
| inspection | | | | | | |
| Test of | ◯ | ◯ | ◯ | ◯ | ◯ | ◯ |
| Discoloration | | | | | | |

As shown in Table 1-Table 10, the colored layer can form into the contact lens and not discolor easily by forming a covalent bond between the reactive group of lens forming material and the sulfonate group of dye of β-sulphatoethyl sulphone substituted with a sulfonate group. In addition, higher concentration of the dye solution used deeper color of the colored layer formed by visual inspection.

While the invention has been described by way of example(s) and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for manufacturing a colored contact lens, comprising steps of:
(a) forming a contact lens by polymerizing a polymerizable lens forming material in a mold, wherein the lens forming material comprises at least one reactive group;
(b) contacting at least a part of the contact lens with a dye solution for a period of time sufficient to form a colored layer within the contact lens, wherein the dye solution comprises at least one dye of β-sulphatoethyl sulphone substituted with a sulfonate group;
(c) immersing the contact lens with colored layer in a fixing solution; and
(d) washing the contact lens;
wherein the colored layer is covalently attached to the contact lens.

2. The method according to claim 1 further comprising a step of: placing the contact lens into a patterned masking mold for masking at least a part of the contact lens before the step (b), wherein the unmasked part of the contact lens contacts the dye solution.

3. The method according to claim 2, wherein the patterned masking mold comprising:
a holding element comprising a patterned masking member for masking the at least a part of the contact lens;
an upper cover capable of coupling with the holding element for clamping the contact lens; and
a contact lens containing spatial area disposed between the holding element and the upper cover;
wherein the patterned masking member masks the at least a part of the contact lens while placing the contact lens into the holding element.

4. The method according to claim 1, wherein the reactive group comprises at least one group of hydroxyl group, amino group, amido group or sulfhydryl group.

5. The method according to claim 1, wherein a concentration of the dye solution is in the range of 0.1% to 2%.

6. The method according to claim 1, wherein the dye of β-sulphatoethyl sulphone substituted with the sulfonate group is selected from a group consisting of C.I. Reactive Yellow 14, C.I. Reactive Yellow 15, C.I. Reactive Yellow 17, C.I. Reactive Orange 7, C.I. Reactive Orange 16, C.I. Reactive Orange 72, C.I. Reactive Orange 78, C.I. Reactive Black 5, C.I. Reactive Red 23, C.I. Reactive Red 49, C.I. Reactive Red 180, C.I. Reactive Blue 19, C.I. Reactive Blue 20 or C.I. Reactive Blue 21 and a combination thereof.

7. The method according to claim 1, wherein in step (b), the time of contacting the contact lens with the dye solution is in the range of 30 minutes to 90 minutes.

8. The method according to claim 1, wherein the fixing solution is an alkali metal hydroxide solution or an alkali metal salt solution.

9. The method according to claim 1, wherein the fixing solution comprises at least one of sodium hydroxide solution, potassium hydroxide solution, sodium bicarbonate solution or sodium carbonate solution.

10. The method according to claim 1, wherein a pH value of the fixing solution is in the range of 11 to 12.5.

11. The method according to claim 1, wherein the time of immersing the contact lens with colored layer in the fixing solution is in the range of 30 minutes to 60 minutes.

12. The method according to claim 1, wherein step (c) further comprises conducting under a heating treatment.

13. The method according to claim 12, wherein the heating treatment is conducted at the temperature in the range of 50° C. to 80° C.

14. The method according to claim 1, wherein the contact lens is washed in water and alcohol in step (d).

15. A colored contact lens which is obtained by the method for manufacturing a colored contact lens according to claim 1.
